(19) United States
(12) Patent Application Publication
(10) Pub. No.: US 2008/0234423 A1
(43) Pub. Date: Sep. 25, 2008

(54) PHYLLOSILICATE MODIFIED RESINS FOR LIGNOCELLULOSIC FIBER BASED COMPOSITE PANELS

(75) Inventors: Sunguo WANG, Edmonton (CA); Hua QIU, Edmonton (CA); John ZHOU, Edmonton (CA); Rob WELLWOOD, Edmonton (CA)

Correspondence Address: EDWARD YOO C/O BENNETT JONES, 1000 ATCO CENTRE, 10035 - 105 STREET, EDMONTON, ALBERTA, AB, T5J3T2, CA

(73) Assignee: ALBERTA RESEARCH COUNCIL INC., Edmonton (CA)

(21) Appl. No.: 12/052,355

(22) Filed: Mar. 20, 2008

Related U.S. Application Data
(60) Provisional application No. 60/896,116, filed on Mar. 21, 2007.

(51) Int. Cl. C08K 3/34; B05D 3/02

(52) U.S. Cl. 524/445; 427/195

(57) ABSTRACT

A method of forming a composite panel or board includes the step of adding phyllosilicate clay to a thermosetting resin and natural fibres. The natural fibres include hardwood fibre, softwood fibre, grain straw, hemp fibre, kenaf fibre, bagasse fibre, palm fibre, canola straw fibre, flax straw fibre, rapeseed straw fibre, wheat straw fibre, oat straw fibre, barley straw fibre, rice straw fibre or rye straw fibre. The thermosetting resin may include phenol formaldehyde, urea formaldehyde, melamine formaldehyde, melamine urea formaldehyde, or methylenediphenyl diisocynanate. The phyllosilicate clay may include nanoparticulate clay and may include natural, modified or synthetic forms of sodium montmorillonite, montmorillonite, nontronite, beidellite, volkonskoite, laponite, hectorite, saponite, sauconite, magadite, kenyaite, stevensite, vermiculite, halloysite, or hydrotactite.

### CROSS REFERENCE TO RELATED APPLICATIONS

This application claims the priority benefit of U.S. Provisional Application No. 60/896,116 filed on Mar. 21, 2007 entitled “Phyllosilicate Clay Modified for Lignocellulosic Fiber Based Composite Resins”, the contents of which are incorporated herein by reference.

### FIELD OF THE INVENTION

The present invention relates to a method of forming natural fibre based composite panels using phyllosilicate clay in a resin-natural fibre system.

### BACKGROUND

Resin accounts for about 20-25% of panel production cost. For instance, in a medium size OSB mill, a 0.1% reduction in cost of resin could lead to approximately $450,000-500,000 of cost reduction annually. Therefore, researchers have been working on reducing the resin cost while maintaining or improving panel properties such as Internal Bond (IB) strength.

There have been alternative suggestions for reaching the above goals. Adding fillers into a resin system is one of them. Inorganic materials such as clay and silica are the most often chosen structural additives employed in the composite material industry. They have been used to react with epoxy resins and phenolic resins during synthesis.

However, the applicants are not aware of any prior art which uses phyllosilicate clay material with thermosetting resins, which resins are ubiquitous in the formation of wood strand based products.

### SUMMARY OF THE INVENTION

The applicants have discovered that phyllosilicate clay may be added to lignocellulosic fibre adhesive solids or resins, while substantially maintaining or even improving panel properties, and while lowering usage of resin. These performance properties have been demonstrated in panels bonded with different thermosetting resins, according to a variety of trials.

In one embodiment, the invention comprises a method of forming a composite panel or board by mixing natural fibres with resin, wax, and phyllosilicate clay, before mat forming and panel pressing. Preferably, the resin is a thermosetting resin. Preferably, in one embodiment, these elements are mixed in the following proportions: 81.0-91.5% natural fibres with 1.5-15.0% resin, 0.5-2.0% wax, and 0.01-1.0% phyllosilicate clay. In one embodiment, the resin to phyllosilicate clay ratio (by weight) is about 1.5 to about 1500. Preferably, the clay and the resins are premixed before the clay-resin mixture is applied for resin blending with the natural fibres. Many mixing methods can be chosen for evenly dispersing clay into resin systems including, but not being limited to, manual shaking, ribbon mixing, tumbler mixing, high shear mixing, multi-mechanism mixing, spray drying (and mixing), ultrasonic homogenizing, and various mechanical homogenizing techniques. In one embodiment, the phyllosilicate clay comprises nanoparticulate clay, as defined below.

Both liquid and powder resins are appropriate for use in the present invention. In one embodiment, when a liquid resin, such as, for example, liquid phenol formaldehyde (LPF) is used, it is preferred to prepare a mixed phyllosilicate clay-LPF suspension and then convert the suspension into powder resins by means of a spray dryer. The resultant powder resin-clay mixtures become more uniform and stable.

### BRIEF DESCRIPTION OF THE FIGURES

FIG. 1 discloses the effect of nanoclay type on bondability (Lap Shear Strength).

FIG. 2 discloses the impact of a high shear mixer (Microfluidics™ High Shear or MHS) pass times on bondability.

FIG. 3 discloses the effect of nanoclay replacement to resin solids on bondability.

### DETAILED DESCRIPTION OF PREFERRED EMBODIMENTS

The present invention provides for a method of preparing clay modified resins for fibre based panels such as OSB, medium density fibreboard (MDF), particleboard, plywood and the like. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications, and equivalents that are included in the spirit and scope of the invention, as claimed herein.

We have found that OSB panel test results show that the addition of phyllosilicate clay into thermosetting wood adhesives maintained or even enhanced most panel properties, whereas the resin mixtures were less costly due to the lower price of the clay material compared with base resins. Both laboratory-made and mill-produced panels indicated similar trends in panel performance.

Natural lignocellulosic fibres are fibres comprising lignin and cellulose found in woody plant cells, including hardwood and softwood species, cereal grain straws, other fibrous plant materials such as hemp and kenaf, residues from agricultural processing such as bagasse and palm fibre, and straws from oilseeds such as canola, flax and rapeseed. Cereal grain straw fibre comprises straw collected from cereal grain crops and includes, but is not limited to, wheat, oats, barley, rice, and rye. All such natural fibres may be useful in the present invention.

Lignocellulosic fibre preparation methods are well known in the art and need not be described herein. The fibres may be used in the form of strands, veneers, and more finely divided fibre elements. The manufacture of and use of such fibres in the creation of boards, panels, and other structural materials, such as OSB, MDF, particle board and the like, with the addition of adhesives or resins, is also well known in the art.

This invention comprises phyllosilicate clay as an additive for conventional wood adhesives to substitute part of resin solids while maintaining ideal panel properties. Suitable resins include thermosetting resins which may include, but are not limited to, phenol formaldehyde (PF), urea formaldehyde (UF), melamine formaldehyde (MF), melamine urea formaldehyde (MUF), 4,4′-methylenediphenyl diisocyanate (MDI), individually or in combinations. Preferably, the resin is a formaldehyde-based resin such as PF, UF, MF, or MUF. The resin content may be about 1.0-15.0% based on the weight of oven dried fibres. Base resin formulations which are suitable for fibre-based composite panels are well known and may be manufactured or commercially available from resin manufacturers. The resins could be liquid or powder based systems as needed.

Phyllosilicate clay, or sheet silicate clay, has a unique layered structure comprising parallel sheets of silicate tetrahedra with Si₂O₅ (or a 2:5 ratio). Without restriction to a theory, it is believed that phyllosilicate clay interacts with natural fibres or adhesives, or both natural fibres and adhesives, during resin mixing and hot pressing where high temperature and pressure are used to heat and cure the fibre-resin-clay-wax matrix. Hot pressing changes the mixture's flowability, improves the mat's compressibility, and also brings out physico-chemical reactions in the fibre-clay-resin-wax system. Without being bound to a theory, we believe that adequately dispersed phyllosilicate clay platelet material swells in the fibre-clay-resin-wax system and forms a very strong interaction with the molecular chains in the system, producing a panel product with enhanced performance.

In one embodiment, the clay additive comprises small, layered clay particles having a large unit area (800 m²/g). The large unit area ensures that many atoms are located near interfaces. The clay should be finely divided, and may preferably be nanoparticulate clay. As used herein, “nanoparticulate clay” refers to clay particles having at least one dimension less than about 1000 nm, preferably less than about 500 nm, more preferably less than about 100 nm, for example, 50, 40, 30, 20 or 10 nm. In one embodiment, clay additive comprises nanoparticulate clay particles.

The nanoparticulate phyllosilicate clay particles also have significantly different surface properties such as energy levels, electronic structure, and reactivity than clay bulk properties. Without being restricted to a theory, we believe that hydroxyl groups on the silicate surface may react with those in the natural fibres or resin molecules, or both the natural fibres and the resin molecules, during the hot pressing of composite panels such as OSB products, leading to panel property enhancements. SEM-EDX analysis indicated that the phyllosilicate clay-PPF mixture is well spread over the strand surface, playing the function as welding points between strand surfaces within a panel. Meanwhile, IR analysis showed that hydroxyl groups in both clay-LPF and clay-PPF systems formed hydrogen bonds during resin cure.

The phyllosilicate clay material of the present invention may include swellable layered clay materials include, but are not limited to, natural or synthetic phyllosilicates, particularly smectic clays such as montmorillonite, nontronite, beidellite, volkonskoite, laponite, hectorite, saponite, sauconite, magadite, kenyaite, stevensite and the like, as well as vermiculite, halloysite, hydrotacite and the like. These layered clays generally comprise particles containing a plurality of silicate platelets with a thickness of about 8-12 Å tightly bound together at interlayer spacing of 4 Å or less, and contain exchangeable cations such as Na⁺, Ca²⁺, K⁺, or Mg²⁺ at the interlayer surfaces. When swelled and mixed, the platelets are preferably dispersed and become fully exfoliated. Preferred clays for the present invention are montmorillonite-based clays. Most preferred phyllosilicate clay is sodium montmorillonite (Na-MMT), one type of smectite, which can be either natural or modified.

Preferred clays are selected, in part, having regard to their molecular structures. Preferred clays have a large specific area and contain many hydroxyl groups on clay surfaces, since these hydroxyl groups also exist in the PF or UF resin. This type of clay is therefore compatible and reacts well with PF or UF through these aforesaid chemical groups. Hydrophilicity of clays is another preferred attribute because PF and UF resins used in the invention are water-based systems. Natural phyllosilicate clay such as sodium montmorillonite (Na-MMT) is therefore one preferred material.

The preparation of suitable nanoparticulate phyllosilicate clay is known in the art and is also commercially available, such as from Nanocor Company of Arlington Heights, Ill., and Cloisite™, commercially available from Southern Clay Products of Widner, United Kingdom.

Liquid composite resins may be prepared by mixing the clay with commercial liquid resins before resin blending. Similar to liquid resins, powder resins can be made at the laboratory or acquired from the market. Preferably, clay may be mixed into the available liquid resin system and then spray-dried into clay composite powder resin. In this way clay can be better dispersed into the resin system and the end powder resin mixture is more stable and uniform. The powder resins are preferably UF or PF.

During spray drying a liquid resin such as LPF resin, the resin is converted into a fine spray; the water in the liquid resin is evaporated by means of a stream of hot air; and the dry, powder product (PPF) is meanwhile separated from the stream of hot air. More evaporation depends on the inlet and outlet temperature of the hot air employed for the spray drying. Considering the thermosetting nature of the LPF resin, the inlet temperature of the hot air is normally adjusted from 180° C. to 210° C., preferably from 190° C. to 200° C. The outlet temperature of the hot air is generally from 70° C. to 95° C., preferably from 80° C. to 90° C. Ideally, the LPF resin pumped into the spray dryer has a resin solid content of 35-45% by weight of the aqueous PF solution and a viscosity of 60 to 320 CPs at 25° C.

The wax may preferably comprise slack wax or emulsified wax. Slack wax is a mixture of petroleum oil and wax, obtained from dewaxing lubricating oil. It is the crude wax produced by chilling and solvent filter-pressing wax distillate. It is a known additive to fibre based panels and acts as a water repellent. Emulsified wax is a wax mixed with detergents so it can be suspended in water. It simplifies the spraying process in some systems. Emulsified wax is not commonly used, but it can be used in panel manufacture. The wax amount may be present in quantities less than about 2.0% by weight of oven dry fibre, preferably above about 1.0%.

Moisture content of the spray dried resin impacts the free flowability of the powder resin. As PPF resin is hygroscopic, higher moisture levels may cause PPF to cake during resin storage. Therefore, the moisture content is preferably controlled to lower levels. A preferred final moisture content for PPF is in the range of about 2% to about 3%. Thermal flowability of the powder resin is mostly related to the molecular weight of the resin. In the spray drying process, heat increases the molecular weight. Thus, feed rate, inlet and outlet temperatures are important conditions for acquiring proper molecular weight and suited thermal flow property thereof. One skilled in the art will easily determine and implement appropriate conditions for the spray drying process.

In this invention, phyllosilicate clay is added into the resin system to replace a certain amount of resin solids in either liquid or powder resins. Sufficient mixing and thus relatively uniform phyllosilicate clay dispersion in the composite resin systems is preferred, along with order of addition and mixing techniques. For liquid resin systems, ultrasonic or mechanical homogenization can be employed to achieve uniform clay dispersion in the mixture. For example, mechanical homogenization by high shear mixing with a commercially available mixer such as a Microfluidics™ high shear mixer provides good results. Powder resin and clay premixing can be conducted by means of manual bottle shaking or other mechanical methods including, but being not limited to, ribbon mixing, tumbler mixing, high shear mixing, multi-mechanism mixing, and spray drying. In each case, the method of mixing is not essential, so long as the phyllosilicate clay is highly dispersed into the resin.

Spray drying is used to convert premixed liquid resin-clay mixture into powder resin-clay mixture. This process completes removing water from the mixed liquid resin while generating more uniform dispersion of phyllosilicate clay in the resultant dried resin-clay mixture. The loading level of clay in the fibre-resin-wax system may be about 0.01-1.0% on the basis of oven dried fibre weight. The weight ratio of resin to clay is 85.0-99.9% to 0.1-15%, preferably 93.0-99.5% to 0.5-7.0%.

Boards may be prepared using conventional hot-pressing techniques. Proper press temperature, press time, pressure, and resin content for making quality composite panels including OSB panels are well known in the art. For composite panels such as OSB, press temperature may vary from 180° C. to 240° C., preferably 200° C.-218° C.; press time may vary from 150 to 300 seconds; pressure changes may vary from 450 to 750 psi, preferably 550-650 psi; and resin content may vary from 1.5-15.0%, preferably 2.5-3.5% for PF and 8-12% for UF based on oven dried fibre weight.

The invention has been described in detail with particular reference to certain preferred embodiments thereof, but it will be understood that variations and modifications can be effected within the spirit and scope of the invention.

### EXAMPLES

The following examples are representative of the claimed invention and are not intended to be limiting thereof.

### Example 1

Table 1 lists different formulations mixing certain percentages of fibre, resin, wax, and phyllosilicate clay in a blender. The percentages are on the oven dried fibre weight basis.

TABLE 1
Lignocellulosic fibres mixing with chemical additives

| Resin Types | Formulations and processes |
|---|---|
| Without clay | 83.0-91.4% fibres were mixed with 1.5-15.0% resin, |
| | and 0.5-2.0% wax before mat forming and panel |
| | pressing |
| With natural clay or | 81.0-91.5% fibres were mixed with 1.5-15.0% resin, |
| modified clay | 0.5-2.0% wax, and 0.01-1.0% clay before mat |
| | forming and panel pressing |

### Example 2

Tables 2 and 3 show the characteristics of industry-grade natural montmorillonite Na (natural gel) and purified natural montmorillonite (Cloisite® Na) used in this invention.

TABLE 2
Chemical components of industry-grade natural
montmorillonite (natural gel)

| Components | % | Components | % |
|---|---|---|---|
| SiO₂ | 61.4 | TiO₂ | 0.2 |
| Al₂O₃ | 18.1 | K₂O | 0.1 |
| Fe₂O₃ | 3.5 | Other | 0.07 |
| Na₂O | 2.3 | H₂O | 7.8 |
| MgO | 1.7 | L.O.I | 4.4 |
| CaO | 0.4 | | |

TABLE 3
Chemical components of Cloisite ® Na

| Components | % | Components | % |
|---|---|---|---|
| SiO₂ | 55.90 | P₂O₅ | <0.01 |
| Al₂O₃ | 19.21 | MnO | <0.01 |
| Fe₂O₃ | 4.28 | Cr₂O₃ | <0.01 |
| CaO | 0.14 | Others | Ba, 40 ppm; Ni, 20 ppm; Sr, 34 ppm; |
| Na₂O | 3.84 | | Zr, 113 ppm; Nb, <10 ppm, Sc, |
| K₂O | 0.10 | | 5 ppm; Appearance: tan powder; |
| TiO₂ | 0.11 | | pH = 9; Specific gravity = 2.8-2.9. |

### Example 3

Table 4 indicates the effect of modified natural clay replacement in the PPF system on OSB panel performance.

The laboratory processing conditions are as below.
The nominal panel dimension: 3′×3′ 7/16″ (914×914×11.1 mm)
Panel structure: three layers, random, face/core=50:50
Panel density: 38 lbs/ft³ (608 kg/m³)
Strands: commercial strands, 3/16″ (4.8 mm) over
Wax: slack wax, 1.2% based on oven dried strand weight
Resin: PPF or clay-PPF, 3% for both face and core based on oven dried strand weight
Moisture content: face: 6-7%, core: 4-5%
Pressing: press temperature=200° C., press time=210 sec.

Clay and PPF are premixed by manual bottle shaking for 10-20 minutes before the mixture is applied into the blender together with fibers, wax, and/or other additives.

Panel test results showed that using the Cloisite® Na-PPF resin mixture achieved better panel performance among the chosen three composite PPF resins.

TABLE 4
Impact of modified clay-PPF resin on laboratory panel properties

| | | | 2-hr boil | | | |
|---|---|---|---|---|---|---|
| | MOE, | MOR, | MOR, | IB, | TS, | LE, |
| Formulations | MPa | MPa | MPa | MPa | % | % |
| Control PPF | 3900 | 24.0 | 10.8 | 0.394 | 16.9 | 0.34 |
| Cloisite ® Na-PPF* | 4000 | 26.3 | 12.2 | 0.424 | 22.7 | 0.31 |

Note:
*Cloisite ® Na is a purified natural montmorillonite.

### Example 4

Table 5 demonstrates the effect of natural gel replacement in the PPF system on OSB panel performance.

The lab processing conditions are as follows.
The nominal Panel dimension: 3′×3′× 7/16″ (914×914×11.1 mm)
Panel structure: three layers, random, face/core=50:50
Panel density: 38 lbs/ft³ (608 kg/m³)
Strands: commercial strands, 3/16″ (4.8 mm) over
Wax: slack wax, 1.2% based on oven dried strand weight
Resin: PPF or clay-PPF, 3% for both face and core based on oven dried strand weight
Moisture content: face: 6-7%, core: 4-5%
Pressing: press temperature=200° C., press time=210 sec.

Natural gel and PPF are premixed by manual bottle shaking for 10-20 minutes before the mixture is applied into the blender together with fibers, wax, and/or other additives.

Panel test results showed that using natural gel to substitute 4% resin solid in the PPF system obviously enhanced all panel properties.

TABLE 5
Impact of phyllosilicate clay-powder PF resins on
laboratory panel properties

| | MOE, | MOR, | 2-hr boil | IB, | TS, | |
|---|---|---|---|---|---|---|
| Formulations | MPa | MPa | MOR, MPa | MPa | % | LE, % |
| Control PPF | 4100 | 22.4 | 10.9 | 0.303 | 19.3 | 0.32 |
| Clay-PPF with | 4200 | 27.0 | 13.6 | 0.357 | 17.1 | 0.27 |
| 4% natural gel | | | | | | |
| replacement of | | | | | | |
| resin solid | | | | | | |

### Example 5

Table 6 shows the effect of natural gel replacement in the LPF system on OSB panel performance.

The lab processing conditions are as below.
The nominal Panel dimension: 3′×3′× 7/16″ (914×914×11.1 mm)
Panel structure: three layers, random, face/core=50:50
Panel density: 38 lbs/ft³ (608 kg/m³)
Strands: commercial strands, 3/16″ (4.8 mm) over
Wax: slack wax, 1.2% based on oven dried strand weight
Resin: LPF or clay-LPF, 4% for both face and core based on oven dried strands weight
Moisture content: face: 6-7%, core: 4-5%
Pressing: press temperature=200° C., press time=210 sec.

Clay-LPF mixture is formulated by using a kitchen mixer. A 3-step process is used to ensure the uniformity of the mixture while effectively avoiding bubbles. The first step is to stir the mixture at 500-800 rpm for 10-20 minutes after adding clay. The second step is to continue stirring the mixture at 900-1100 rpm for another 20-40 minutes, and the last step is to vacuum the resin mixture for about 20-35 minutes. After this whole procedure the clay-LPF mixture is ready for blending with fibers, wax, and/or other additives.

Panel test results indicate that using clay to substitute 1% resin solid in the liquid PF system still kept most of panel properties at the same level as using pure LPF resin while clay-LPF brings the resin cost down.

TABLE 6
Impact of clay-LPF resins on laboratory panel properties

| | MOE, | MOR, | 2-hr boil | IB, | TS, | LE, |
|---|---|---|---|---|---|---|
| Formulations | MPa | MPa | MOR, MPa | MPa | % | % |
| Control LPF | 4100 | 28.8 | 14.2 | 0.421 | 12.8 | 0.25 |
| Clay-LPF with | 4200 | 29.3 | 14.4 | 0.428 | 13.0 | 0.25 |
| 1% replacement | | | | | | |
| of resin solid | | | | | | |

### Example 6

Table 7 summarizes the impact of natural gel substitution of UF resin solid on OSB panel properties.

Panel processing conditions are as follows.
Panel dimension: 3′×3′× 7/16″ (914×914×11.1 mm)
Panel structure: three layers, random, face/core=50:50
Panel density: 38 lbs/ft³ (608 kg/m³)
Strands: commercial strands, 3/16″ (4.8 mm) over
Wax: slack wax, 1.2% based on oven dried strand weight
Resin: UF or clay-UF, 10% for both face and core based on oven dried strand weight
Moisture content: face: 6-7%, core: 4-5%
Pressing: press temperature=190° C., press time=255 sec.

Clay-UF mixture is formulated by using a kitchen mixer. A 3-step process is used to ensure the uniformity of the mixture while effectively avoiding bubbles. The first step is to stir the mixture at 500-800 rpm for 5-15 minutes after adding clay. The second step is to continue stirring the mixture at 900-1100 rpm for another 15-30 minutes, and the last step is to vacuum the resin mixture for about 10-25 minutes. After this whole procedure the clay-UF mixture is ready for blending with fibers, wax, and/or other additives.

Panel test results illustrate that 1% and 2% clay replacements led to 28% and 11% IB improvements, respectively while other panel properties demonstrate insignificant decreases.

TABLE 7
Effect of clay-liquid UF resins on laboratory panel properties

| | MOE, | MOR, | IB, | TS, | LE, |
|---|---|---|---|---|---|
| Formulations | MPa | MPa | MPa | % | % |
| Control UF | 4600 | 28.3 | 0.214 | 11.0 | 0.30 |
| Clay-UF with 1% replacement* | 4400 | 26.0 | 0.275 | 11.6 | 0.32 |
| Clay-UF with 2% replacement** | 4500 | 25.6 | 0.238 | 11.5 | 0.31 |

Note:
*mixing 99% UF solid with 1% clay;
**mixing 98% UF solid with 2% clay.

### Example 7

Table 8 indicates the relationship of laboratory spray dried clay-PF resin on panel properties.

The laboratory processing conditions are as below.
The nominal Panel dimension: 3′×3′× 7/16″ (914×914×11.1 mm)
Panel structure: three layers, random, face/core=50:50
Panel density: 38 lbs/ft³ (608 kg/m³)
Strands: commercial strands, 3/16″ (4.8 mm) over
Wax: slack wax, 1.2% based on oven dried weight
Resin: PPF or clay-PPF, 3% for both face and core based on oven dried strands weight
Moisture content: face: 6-7%, core: 4-5%
Pressing: press temperature=200° C., press time=270 sec. (longer time because face resin recipe was used for all layers)

Clay-LPF mixture is formulated by using a kitchen mixer. A 3-step process is used to ensure the uniformity of the mixture while effectively avoiding bubbles. The first step is to stir the mixture at 500-800 rpm for 10-20 minutes after adding clay. The second step is to continue stirring the mixture at 900-1100 rpm for another 20-40 minutes, and the last step is to vacuum the resin mixture for about 20-35 minutes. After this whole procedure the clay-LPF mixture is ready for spray drying into powder PF-clay mixture. The spray drying was conducted by means of a laboratory-scale spray dryer.

Table 8 illustrates that spray drying premixed clay-LPF into PPF led to improved panel properties in comparison with using commercial PPF produced from the same LPF recipe but without 1% clay substitution to resin solid.

TABLE 8
Effect of spray dried clay-PF resin on panel properties

| | MOE, | | | | LE, |
|---|---|---|---|---|---|
| Formulations | MPa | MOR, MPa | IB, MPa | TS, % | % |
| Control PPF* | 4100 | 27.1 | 0.411 | 14.6 | 0.27 |
| Lab spray dried PF | 4300 | 27.8 | 0.438 | 14.3 | 0.28 |
| from clay-LPF** | | | | | |

Note:
*commercial face PPF resin used for all layers;
**clay-LPF resin was premixed before spray drying by mixing face liquid PF with 1% phyllosilicate clay replacement of resin solid.

### Example 8

Table 9 shows the mill trial results in regards to panel properties. Natural gel and PPF are premixed by bottle shaking for 10-20 minutes or using Glenmills' Turbula Shaker Mixer (Type T2 F) to blend for 6-10 minutes before the mixture is applied into the blender together with fibers, wax, and other additives.

Major processing parameters are:
Panel density=35 lbs/ft³ (560 kg/m³); resin content=2.7% for both face and core based on oven dried strand weight; panel structure: O2 (face/core=55/45); panel thickness=18 mm; panel dimension: 8′×16′ (2838×4876 mm).
Press time=265 s; press temperature=217° C.; pressing cycle=280 s.
All processing conditions were the same for both control PPF and clay-PPF resin conditions.

After pressing, one pressload panels (48 4′×8′ panels) were randomly taken from pure PPF resin group (control, 100% PPF), and one pressload panels (48 4′×8′ panels) from clay-PPF resin group (4% clay+96% PPF). Then, 12 panels were randomly chosen from each pressload for panel property tests.

When clay-PPF resins were used in the mill, the end OSB flooring products looked solid without obvious defects on faces and edges, and without distinct difference in appearance from control panels. X-ray scanning did not show significant density variations between control panels and clay-PPF panels. Test results indicated that clay-PPF panels generally achieved better panel properties than control panels even though 4% PPF in the clay-PPF mixture was substituted by much cheaper industry grade natural clay (natural gel) for both face and core resins. The bending properties enhanced by up to 9%, dimensional stability 8%, whilst IB almost kept the same.

TABLE 9
Effect of natural gel in powder PF resin on mill panel properties

| | | | | | | 2-hr. boil | | |
|---|---|---|---|---|---|---|---|---|
| | MOE, | | | | | MOR, | | |
| | MPa | | MOR, MPa | | IB, | MPa | | |
| Formulations | Para. | Perp. | Para. | Perp. | MPa | Para. | Perp. | TS, % |
| Control PF | 6100 | 2900 | 29.7 | 17.9 | 0.256 | 12.9 | 8.8 | 9.8 |
| Nano-PF-B | 6600 | 3000 | 32.4 | 18.7 | 0.253 | 13.2 | 9.3 | 8.5 |

### Example 9

Table 10 shows the effect of Microfluidizer High Shear (MHS) Processing in the LPF system on OSB panel performance.

The lab processing conditions are as below:
The nominal Panel dimensions: 3′×3′× 7/16″ (914×914×11.1 mm)
Panel Structure: three layers, random, face/core=50:50
Panel density: 38 lbs/ft³ (608 kg/m³)
Strands: commercial strands, 3/16″ (4.8 mm) over
Wax: slack wax, 1.2% based on oven dried strand weight
Resin: LPF or MHS-mixed nanoclay LPF, 4% for both face and core based on oven dried strands weight
Moisture content: face: 6-7%, core 4-5%
Pressing: press temperature=200° C., press time=210 sec. MHS-mixed nanoclay-LPF mixture is formulated by using a Microfluidics™ High Shear (MHS) Processor. The clay-LPF mixture is pre-cooled to 4° C. and subjected to the processor at 10,000 psi using a H30Z (200 μm) interaction chamber. The mixture may be recirculated through the system up to 3 times to ensure consistency. After this whole procedure the nanoclay-LPF mixture is ready for blending with fibers, wax, and/or other additives.

Panel tests indicate that using nanoclay in the liquid PF system led to a 10% IB improvement, and a 11% TS improvement, while other panel properties demonstrate insignificant changes.

TABLE 10
Effect of nanoclay-LFP resins on laboratory panel properties

| | MOE, | MOR, | IB, | | | |
|---|---|---|---|---|---|---|
| Formulations | MPa | MPa | MPa | TS, % | WA, % | LE, % |
| Control LPF | 4400 | 23.5 | 0.225 | 14.3 | 31.0 (0.6) | 0.31 |
| | (322) | (1.6) | (0.021) | (0.7) | | (0.04) |
| MHS-mixed | 4600 | 24.7 | 0.248 | 16.0 | 30.8 (0.5) | 0.34 |
| nanoclay- | (231) | (0.8) | (0.058) | (0.6) | | (0.05) |
| LPF | | | | | | |

### Example 10

Table 11 shows the effect of Microfluidizer High Shear (MHS) Processing in the UF system on OSB panel performance.

The lab processing conditions are as below:
The nominal Panel dimensions: 3′×3′× 7/16″ (914×914×11.1 mm)
Panel Structure: three layers, random, face/core=50:50
Panel density: 38 lbs/ft³ (608 kg/m³)
Strands: commercial strands, 3/16″ 4.8 mm) over
Wax: slack wax, 1.2% based on oven dried strand weight
Resin: UF or MHS-mixed nanoclay UF, 4% for both face and core based on oven dried strands weight
Moisture content: face: 6-7%, core 4-5%
Pressing: press temperature=200° C., press time=210 sec.

MHS-mixed nanoclay-UF mixture is formulated by using a Microfluidics™ High Shear (MHS) Processor. The clay-UF mixture is pre-cooled to 4° C. and subjected to the processor at 10,000 psi using a H30Z (200 μm) interaction chamber. The mixture may be recirculated through the system up to 3 times to ensure consistency. After this whole procedure the nanoclay-UF mixture is ready for blending with fibers, wax, and/or other additives.

Panel tests indicate that using nanoclay in the liquid UF system led to a 12% IB improvement, while other panel properties demonstrate insignificant changes.

TABLE 11
Effect of nanoclay-UF resins on laboratory panel properties

| | MOE, | MOR, | IB, | | | |
|---|---|---|---|---|---|---|
| Formulations | MPa | MPa | MPa | TS, % | WA, % | LE, % |
| Control UF | 4600 | 23.3 | 0.251 | 18.5 | 34.6 (3.7) | 0.37 |
| | (336) | (3.3) | (0.075) | (1.9) | | (0.03) |
| MHS-mixed | 4300 | 22.1 | 0.283 | 17.6 | 34.8 (2.4) | 0.32 |
| nanoclay-UF | (153) | (1.8) | (0.020) | (2.2) | | (0.03) |

Previous examples showed the OSB panel performance was improved by the addition of MHS-mixed nanoclay-resin mixtures. The bondability of each resin-nanoclay mixture was tested using the lap shear strength. It was found that nanoclay substitution to LPF resin solids could lead to resin cost reduction considering that the price of nanoclay (especially natural gel) is much cheaper than LPF. A similar bondability performance can also be kept to that of pure LPF resin, if not better.

Summary of Results:
Montmorillonite (MMT) based nanoclays, either natural ones (natural gel and Na-MMT) or modified ones (30B-MMT), led to bondability (lap shear strength) improvements after 3.4% substitution to PF resin solids.
Up to 3 MHS passes, bondability of the nanoclay-LPF mixtures was still kept or enhanced with 3.4% nanoclay replacement to PF resin solids.
When 3 MHS passes were conducted on 1.7 to 6.8% nanoclay substitution to resin solids, bondability of nanoclay-LPF mixtures was higher than that of pure LPF resin.
The pH values of nanoclay-LPF resin mixtures were close to those of pure LPF resins, but their viscosities changed a lot, particularly for resin mixture with very high nanoclay substitutions and/or many MHS passes.
Based on viscosity and bondability results, as well as resin uniformity and stability, it is suggested that 5-minute agitator premixing plus 1 or 2 MHS passes should be used for the preparation of nanoclay-LPF resins.

General Procedure to Test Bondability

The general procedure to test bondability is as follows:

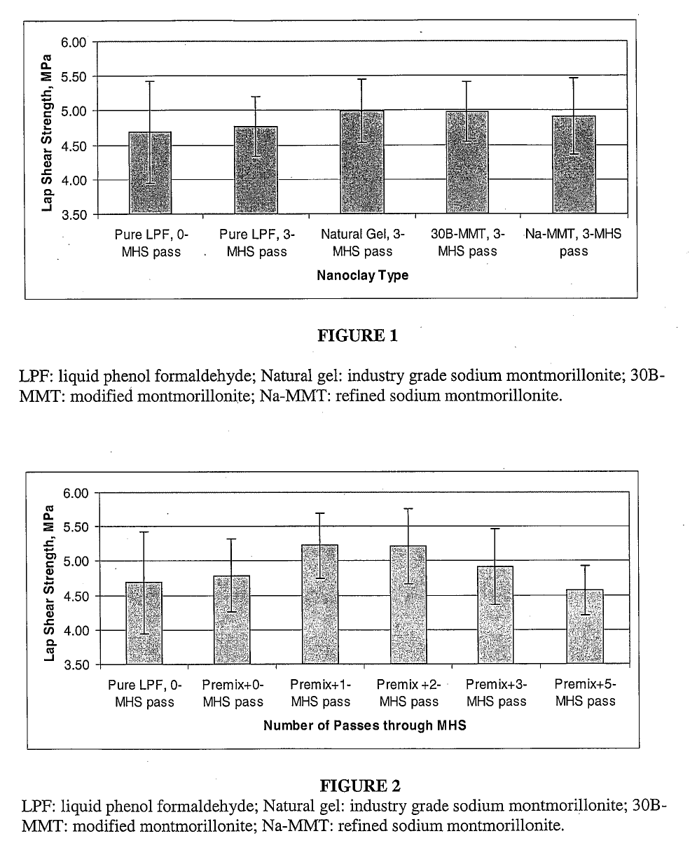

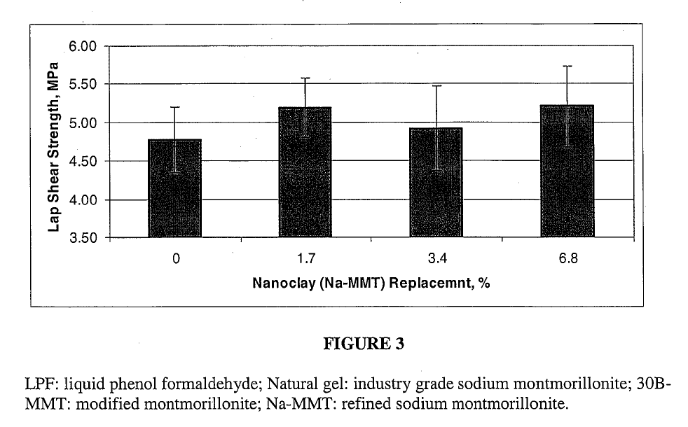

The lap shear test is an effective approach to evaluate bondability differences of varied resin samples or formulations under well controlled pressing conditions. Twenty replicates were tested for both pure LPF resins and nanoclay-LPF mixtures (FIGS. 1-3).

The lab processing conditions are as below:
strands: aspen, 100 mm×20 mm×0.685 mm, conditioned at 50% RH and 20° C.;
strand moisture contents before and after conditioning: 5.1% and 6.0% respectively;
pressing time: 90 seconds;
pressing temperature: 150° C.

After hot pressing, resin was cured and shear tests were then conducted on the glueline. By dividing the failure load by the contact area of the two strands, lap shear strength (bondability) was calculated for every individual test. The average of 20 replicates, were used to compare with that of different resin formulas. Table 12 below shows the viscosity and pH values of nanoclay-LPF resins.

TABLE 12
Viscosity and pH Values of Nanoclay-LPF Resins

| | Nanoclay | No. of MHS | Viscosity, | pH |
|---|---|---|---|---|
| Nanoclay Type | Replacement, % | Passes | CPS | Value |
| N/A (pure LPF) | N/A | 0 | 162 | 10.48 |
| N/A (pure LPF) | N/A | 3 | 153 | 10.48 |
| Natural Gel | 3.4 | 3 | 445 | 10.40 |
| 30B-MMT | 3.4 | 3 | 156 | 10.40 |
| Na-MMT | 3.4 | 1 | 415 | 10.33 |
| Na-MMT | 3.4 | 3 | 2080 | 10.44 |
| Na-MMT | 3.4 | 5 | 3498 | 10.43 |
| Na-MMT | 3.4 | 2 | 1209 | 10.39 |
| Na-MMT | 6.8 | 3 | 5568 | 10.41 |
| Na-MMT | 1.7 | 3 | 685 | 10.52 |
| Na-MMT | 3.4 | premixing only | 175 | 10.30 |

What is claimed is:

1. A lignocellulosic fibre based composite panel, comprising:
(a) a plurality of lignocellulosic fibres, a substantial portion of which are disposed substantially parallel to the plane of the panel;
(b) a thermosetting resin mixed in intimate contact with the lignocellulosic fibres; and
(c) a finely divided phyllosilicate clay, dispersed in said thermosetting resin; and

2. The composite panel of claim 1 wherein said lignocellulosic fibres comprises hardwood fibre, softwood fibre, hemp fibre, kenaf fibre, bagasse fibre, palm fibre, canola straw fibre, flax straw fibre, rapeseed straw fibre, wheat straw fibre, oat straw fibre, barley straw fibre, rice straw fibre or rye straw fibre, or mixtures thereof.

3. The composite panel of claim 1 which is an OSB or MDF panel.

4. The composite panel of claim 1 wherein said solid thermosetting resin comprises phenol formaldehyde, urea formaldehyde, melamine formaldehyde, melamine urea formaldehyde, or methylenediphenyl diisocynanate, or mixtures thereof.

5. The composite panel of claim 1 wherein said phyllosilicate clay comprises natural, modified or synthetic forms of montmorillonite, sodium montmorillonite, nontronite, beidellite, volkonskoite, laponite, hectorite, saponite, sauconite, magadite, kenyaite, stevensite, vermiculite, halloysite, or hydrotactite, or any mixtures thereof.

6. The composite panel of claim 5 wherein the phyllosilicate clay comprises nanoparticles.

7. The composite panel of claim 1 further comprising a wax mixed with said thermosetting resin whereby said wax repels water from said lignocellulosic fibres.

8. The composite panel of claim 7 wherein said wax comprises slack wax or emulsified wax.

9. The composite panel of claim 1 wherein the thermosetting resin comprises a liquid resin, and the phyllosilicate clay is mixed with the resin prior to mixing of the other elements.

10. The composite panel of claim 9 wherein the phyllosilicate clay is mixed with the liquid thermosetting resin by high shear mixing.

11. The composite panel of claim 10 wherein the mixed phyllosilicate clay and liquid resin mixture is dried into a solid resin-clay mixture prior to formation of the panel.

12. A method for producing a lignocellulosic fibre based composite panel, the method comprising the steps of:
(a) providing dried lignocellulosic fibres;
(b) dispersing finely divided phyllosilicate clay in a thermosetting resin;
(c) coating said lignocellulosic fibres with the mixture of the phyllosilicate clay and thermosetting resin;
(d) depositing the said lignocellulosic fibres in a mat such that a substantial portion of the lignocellulosic fibres are substantially parallel to the plane of the mat;
(e) applying to the said mat sufficient heat and pressure so that the thermoplastic resin cures and adheres together the said lignocellulosic fibres into a structurally integral panel.

13. The method of claim 12 wherein dispersing the phyllosilicate clay in the thermosetting resin comprises the step of mixing phyllosilicate clay with said thermosetting resin in a powdered state.

14. The method as set forth in claim 12 wherein dispersing the phyllosilicate clay in the thermosetting resin comprises the steps of:
(a) mixing the phyllosilicate clay with said thermosetting resin in a liquid state;
(b) producing a powdered mixture of thermosetting resin and phyllosilicate clay by drying the mixture of the phyllosilicate clay and the thermosetting resin.

15. The method of claim 14 wherein the powdered mixture is produced by contacting an atomized spray of liquid resin-clay mixture with a heated air stream.

16. The method of claim 14 wherein the phyllosilicate clay is mixed with the resin by mechanical homogenization or ultrasonic homogenization.

17. The method of claim 16 wherein the phyllosilicate clay is mixed with the resin by high shear mixing.

18. The method of claim 12 wherein said lignocellulosic fibres comprise hardwood fibre, softwood fibre, grain straw, hemp fibre, kenaf fibre, bagasse fibre, palm fibre, canola straw fibre, flax straw fibre, rapeseed straw fibre, wheat straw fibre, oat straw fibre, barley straw fibre, rice straw fibre or rye straw fibre, or mixtures thereof.

19. The method of claim 12 wherein said thermosetting resin comprises phenol formaldehyde, urea formaldehyde, melamine formaldehyde, melamine urea formaldehyde, or methylenediphenyl diisocynanate, or mixtures thereof.

20. The method of claim 12 wherein said phyllosilicate clay comprises natural, modified or synthetic forms of sodium montmorillonite, montmorillonite, nontronite, beidellite, volkonskoite, laponite, hectorite, saponite, sauconite, magadite, kenyaite, stevensite, vermiculite, halloysite, or hydrotactite, or any mixtures thereof.
